(19) United States
(12) Patent Application Publication
(10) Pub. No.: US 2013/0341473 A1
(43) Pub. Date: Dec. 26, 2013

(54) Eyewear Holding Device

(71) Applicant: Kevin Narans, Evergreen, CO (US)

(72) Inventor: Kevin Narans, Evergreen, CO (US)

(21) Appl. No.: 13/531,836

(22) Filed: Jun. 25, 2012

(51) Int. Cl. A47F 7/02; F16B 47/00

(52) U.S. Cl. 248/205.3; 248/309.1

(57) ABSTRACT

An eyewear holding device for the purpose of holding and securing eyewear in easy to access and convenient locations throughout the home, automobile, boat, or office, etc., is disclosed in the present invention. Said comprises a base, a temple holder member attached to the base to form storage space for eyewear. The temple holder is constructed in a V shape that prevent the eyewear from moving around in the holding device. A fasten mean is attached to the base allowing the eyewear holding device being mounted to a surface.

### BACKGROUND OF THE INVENTION

1. Field of the Invention

The present invention relates to an eyewear holding device, and more particularly an eyewear holding device the purpose of holding and securing eye glasses and sun glasses in easy to access and convenient locations.

Eyewear, such as eye glasses, protective glasses and sun glasses, are commonly worn in daily life. For example, operator of motor vehicles, such as cars, trucks, boats, aircrafts, often wear prescriptive eye glasses, or sun glasses, or protective glasses in the course of operating motor vehicles. And sometimes the operator needs to remove the glasses and place them for the purpose of storage. Under these situations, the operator faces problems to easily access to glasses at a convenient location, or easily put glasses to the storage places without being distracted from safely operation the vehicle. Also very often, in an automobile, glasses are stored in different locations throughout the vehicle, such as in a glove compartment, in a dash board, under the seat. As a result, the glasses are easily broken, sat on. Also in home or office, an easily accessible storage for glasses is also desirable. This may prevent unused eyewear from being scratched, broken and lost.

So what is in need is an eyewear holding device allowing an easy access and providing unused glasses safe storage in accessible locations and from being damaged, broken or lost.

2. Description of Related Art Some related prior inventions are disclosed as prior art herein. More specifically, by way of example, U.S. Pat. No. 6,283,423 to discloses an eyewear holding device for engaging a selected surface within an automobile. U.S. Pat. No. 5,592,244 discloses a removable holding device for eyeglasses. U.S. Patent Publication No. US 2003/0000977 A1 discloses a portable eyeglasses holding device.

### SUMMARY OF THE INVENTION

In an exemplary embodiment of the present invention, there is disclosed an eyewear holding device, The holding device comprises a base, a temple holder member attached to the base to form storage space for eyewear. The temple holder is constructed in a V shape that prevent the eyewear from moving around in the holding device. A fasten mean is attached to the base allowing the eyewear holding device being mounted to a surface.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an illustration of an eyewear holding device of present invention.

FIG. 2 is an illustration of a pair of eyeglasses in the eyewear holding device of present invention.

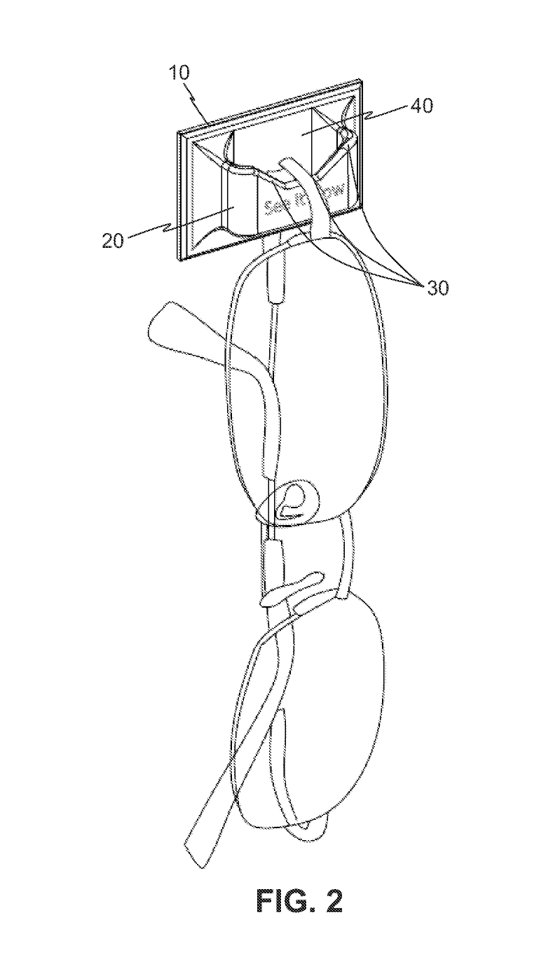

### DESCRIPTION OF THE PREFERRED EMBODIMENT

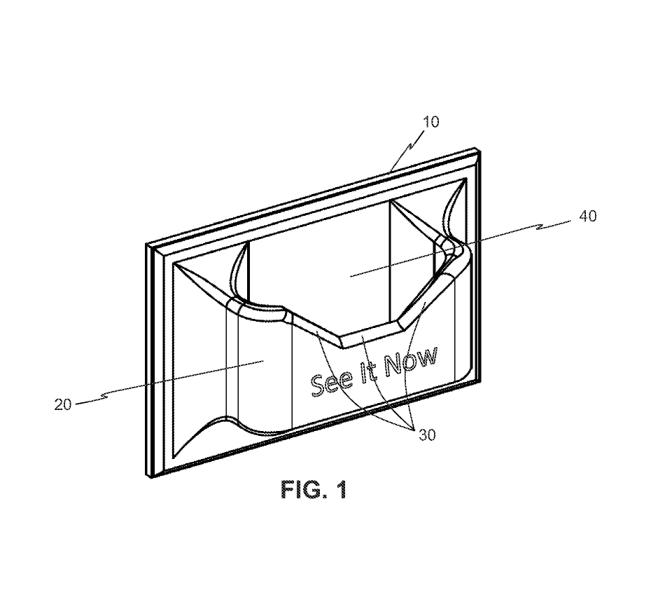

Referring to FIG. 1, there is disclosed an eyewear holding device, and more particularly an eyewear holding device the purpose of holding and securing eye glasses and sun glasses in easy to access and convenient locations.

The eyewear holding device comprise a base 10, a temple holder member 20 attached to the base to form storage space 40 for said eyewear, and a fasten mean is attached to the other side of base allowing the eyewear holding device being mounted to a surface. The temple holder is constructed in a V shape 30 that prevent the eyewear from moving around in the holding device.

In one embodiment of the present invention, said eyewear holding device is made of plastic, metal, wood or any other commercially used materials. In another embodiment of the present invention, said eyewear holding device is made in one color or combinations of colors.

In one embodiment of the present invention, the V shape is made of a small diameter plastic coated cable.

Yet in another embodiment of the present invention, said fasten mean is a double stick adhesive tape.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An eyewear holding device comprising:
a. a base;
b. a temple holder member attached to said base forming a storage space for eyewear; and
c. a fasten mean to mount said eyewear holding device on a surface.

2. An eyewear holding device of claim 1, wherein said temple holder member is made in V shape to prevent eyewear from moving.

3. An eyewear holding device of claim 2, wherein said eyewear holding device is made of plastic, metal, wood or any other commercially used materials.

4. an eyewear holding device of claim 2, wherein said eyewear holding device is made in one color or combination of colors.

5. An eyewear holding device of claim 2, wherein said V shape is made of a small diameter plastic coated cable.

6. An eyewear holding device of claim 2, wherein said fasten mean is a double stick adhesive tape.
